(19) United States
(12) Patent Application Publication
(10) Pub. No.: US 2007/0148270 A1
(43) Pub. Date: Jun. 28, 2007

(54) TIRE CURING MOULD FORMED WITH INTERNAL HOLES

(75) Inventors: Woon-Jae Jung, Incheon (KR); Kyu-Chang Shim, Incheon (KR); Jae-Hoon Lee, Incheon (KR)

Correspondence Address: HAMRE, SCHUMANN, MUELLER & LARSON, P.C., P.O. BOX 2902, MINNEAPOLIS, MN, 55402-0902, US

(73) Assignee: KOREA INSTITUTE OF INDUSTRIAL TECHNOLOGY, Chungnam (KR)

(21) Appl. No.: 11/683,807

(22) Filed: Mar. 8, 2007

(30) Foreign Application Priority Data
Sep. 10, 2004 (KR) 10-2004-0072426

(51) Int. Cl. B29D 29/00

(52) U.S. Cl. 425/54; 425/28.1

(57) ABSTRACT

Disclosed is a tire curing mould with internal holes including a plurality of segment moulds disposed in a circumferential direction of a tire and assembled to each other, and a plurality of holes formed through the segment moulds, characterized in that each of the segment moulds 100 has a through hole 110 formed in a circumferential direction of the segment mould 100, whereby it is possible to provide a high quality tire which is lightweight and easy to maintain, and has excellent durability and high heat transfer efficiency.

### TECHNICAL FIELD

The present invention relates to a tire curing mould with internal holes, and more particularly, to a tire curing mould with internal holes which is lightweight, and has excellent durability and heat transfer effects, and easy maintenance characteristics.

### BACKGROUND ART

Generally, a tire for a vehicle includes a tread, shoulders, sidewalls, beads, carcass plies, belts, and so on. A green tire, in which the above components are engaged with each other, is cured through a tire curing process to complete the tire. The tire curing process is a process of mixing a rubber component with a curing agent and applying a predetermined pressure and a predetermined temperature to the mixture to provide elasticity and strength to the tire.

Specifically, the tire curing process is performed by applying high temperature and pressure in a state that the green tire is disposed between a curing mould and a bladder. At this time, typically, the high temperature is transmitted from the curing mould and the bladder, and the pressure is transmitted from the bladder.

The tire curing mould is classified into various types, typically, a segment type divided in a radial direction and a dual type divided into upper and lower halves.

FIG. 1 is a perspective view of a conventional segment type's tire curing mould.

As shown in FIG. 1, the tire curing mould 1 is divided into 8 segments (the number is arbitrary), which are assembled to each other to support an outer surface of the tire.

In addition, referring to its cross-sectional structure, an inner surface of the mould 1 has a complementary shape to conform to the tread of the tire, and a plurality of vent holes 4 are formed through the mould from the inner surface to an outer surface to discharge inner air during the curing process.

The mould 1 is formed to conform to an outer shape of the tire, without another specific inner component.

The tire curing mould 1 may be made of an aluminum alloy such as JIS AC4D, AC3A, AC7A, and so on.

As shown in FIG. 2, during an actual curing process, a container 3 is assembled to the mould 1 to perform the curing process. The container 3, which is conventionally made of steel, supports the segments 2 and functions as a mould for forming the sidewalls of the tire. The container 3 also has a plurality of vent holes passing through the container 3 in a radial direction.

### DISCLOSURE

Technical Problem

In the conventional tire curing mould, since stress due to the curing pressure is largely concentrated at a lower side end of the mould (shoulders of the tire), the lower side is likely to be damaged or deformed during repeated operations. As a result, circularity of the tire is remarkably decreased to make it impossible to meet a quality standard.

In addition, since the heat supplied from the exterior of the tire mould is provided from a heat pack disposed at an outer surface of the mould, its heat transfer efficiency is very low.

Further, due to its heavyweight, its handling is very inconvenient, and its material such as an aluminum alloy is very expensive.

Furthermore, since the vent hole passing through in the radial direction is very long, a rubber spread out during the curing process should be periodically removed through the drilling operation, which leads to a decrease of productivity of the tire.

Technical Solution

Therefore, the present invention has been made in view of the above-mentioned problems, and it is an object of the present invention to provide a tire curing mould with internal holes which is lightweight and easy to maintain, and has excellent durability and heat transfer effects.

In order to accomplish the above object, there is provided a tire curing mould with internal holes including a plurality of segment moulds disposed in a circumferential direction of a tire and assembled to each other, and a plurality of holes formed through the segment moulds, wherein each of the segment moulds has a through hole formed in a circumferential direction of the segment mould.

Preferably, at least two through-holes are formed in the segment mould symmetrically about a centerline of a cross-section of the segment mould.

Preferably, the through-hole disposed far from the centerline has a size smaller than that of the through-hole disposed adjacent to the centerline.

In addition, preferably, the through-hole has an oval shape having a long axis in a lateral direction of the tire, or a circular shape.

Preferably, the through-hole has a flat bottom surface approximately parallel to an inner surface of the segment mould.

In addition, preferably, at least one vent hole is formed from the inner surface of the segment mould to the through-hole.

### DESCRIPTION OF DRAWINGS

The foregoing and other objects, features and advantages of the present invention will become more apparent from the following detailed description when taken in conjunction with the accompanying drawings in which:

FIG. 1 is a partially exploded perspective view of the structure, of a conventional tire curing mould;

FIG. 2 is a partially exploded perspective view of an assembled structure of the conventional tire curing mould and a container;

FIG. 3 is a partially exploded perspective view of a tire curing mould in accordance with an exemplary embodiment of the present invention;

FIG. 4 is a partially exploded perspective view of an assemble structure of the tire curing mould and a container in accordance with an exemplary embodiment of the present invention;

FIGS. 5A and 5B are perspective views of assembled structures of a segment of another embodiment of the tire curing mould and the container in accordance with the present invention;

FIGS. 6A and 6B are perspective views of segments of the tire curing mould in accordance with the present invention;

FIGS. 7A and 7B are diagrams representing a displacement distribution and a stress distribution as structure analysis results of the structure of FIG. 6A, respectively;

FIGS. 8A and 8B are diagrams representing a displacement distribution and a stress distribution as structure analysis results of the structure of FIG. 6B, respectively; and

FIG. 9 is a diagram showing the dimension of the tire curing mould used in the structure analysis.

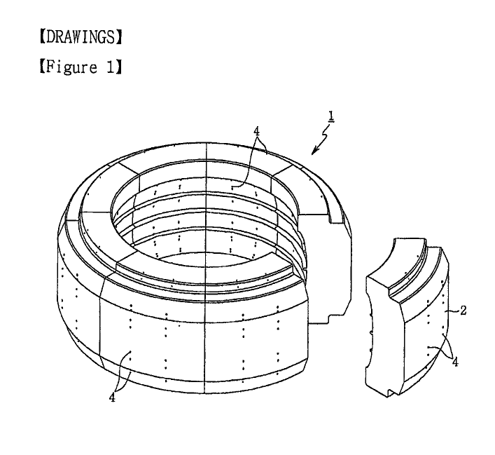

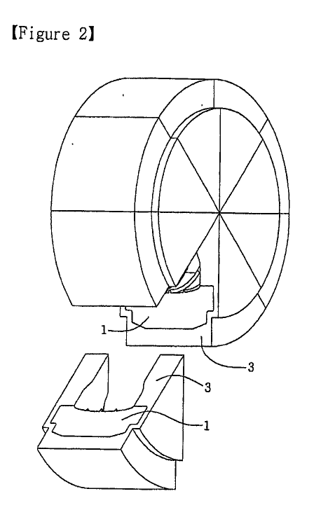

### BEST MODE

Reference will now be made in detail to the preferred embodiments of the present invention. In the following description of the present invention, a detailed description of known functions and configurations incorporated herein will be omitted when it may make the subject matter of the present invention rather unclear,

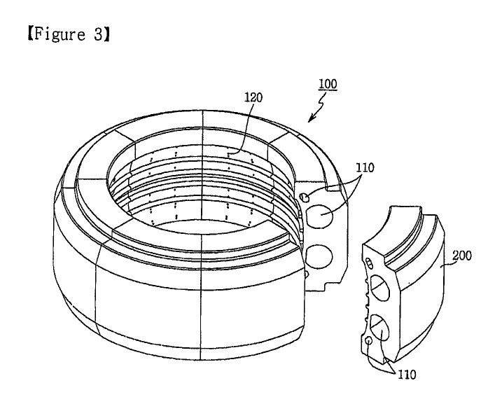

FIG. 3 to 6 illustrate components of a tire curing mould with internal holes in accordance with an exemplary embodiment of the present invention.

As shown, the tire curing mould with internal holes in accordance with the exemplary embodiment of the present invention includes a plurality of segment moulds 100 disposed in a circumferential direction and assembled to each other. Each segment mould 100 has vent holes 120 formed from its inner surface.

In addition, the segment mould 100 has through holes 110 formed through the mould 100 in a circumferential direction. In this process, preferably, at least two through-holes 110 are formed in a symmetric manner about a centerline of a cross-section of the segment mould 100. At this time, preferably, the through-hole placed far from the centerline, i.e., the through-hole adjacent to a shoulder of the tire has a size smaller than that of the through-hole placed adjacent to the centerline. As a result, it is possible to make the tire lightweight and uniform the stress distribution.

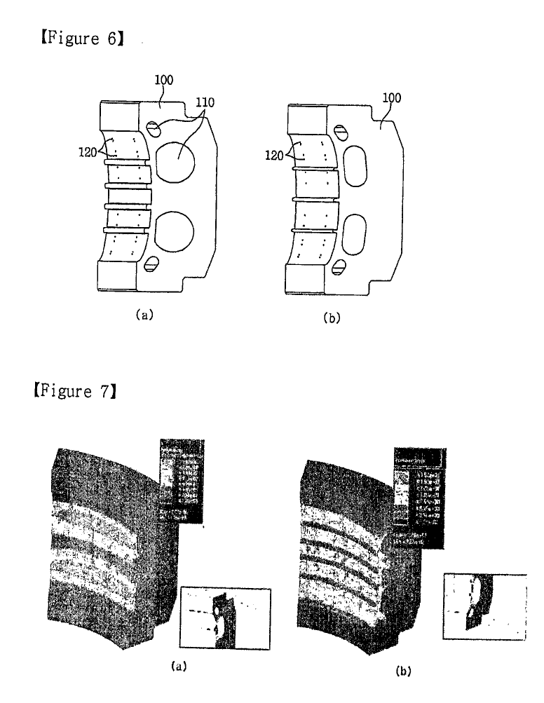

Further, as shown in FIGS. 6A and 6B, the through-hole 110 may have an oval shape having a long axis in a lateral direction of the tire, or a circular shape. Furthermore, as shown in FIG. 6B, the through-hole 110 has a flat bottom surface approximately parallel to an inner surface of the segment mould, thereby more effectively alleviating the stress on a contact part of a green tire.

In addition, preferably, the vent holes 120 are formed from the inner surface of the segment mould 100 to the through-hole 110. Therefore, during a tire curing process, inner air passes through the vent holes 120 via the through-holes 110 to be discharged through gaps between the segment moulds 100. Since the through-hole 110 has an area several tens of times larger than that of the vent hole 120, the inner air can be more readily discharged.

In addition, it is possible to prevent rubber spread out during the curing process from being stuck in the moulds to thereby making its maintenance convenient,

Of course, several holes of the vent holes 120 may pass through from an inner surface to an outer surface of the segment mould 100, without passing through the through-hole 110.

Meanwhile, a separate heat source (not shown) may be inserted into the through-hole 110. Therefore, since a distance between the green tire and the heat source becomes short, it is possible to increase heat transfer efficiency.

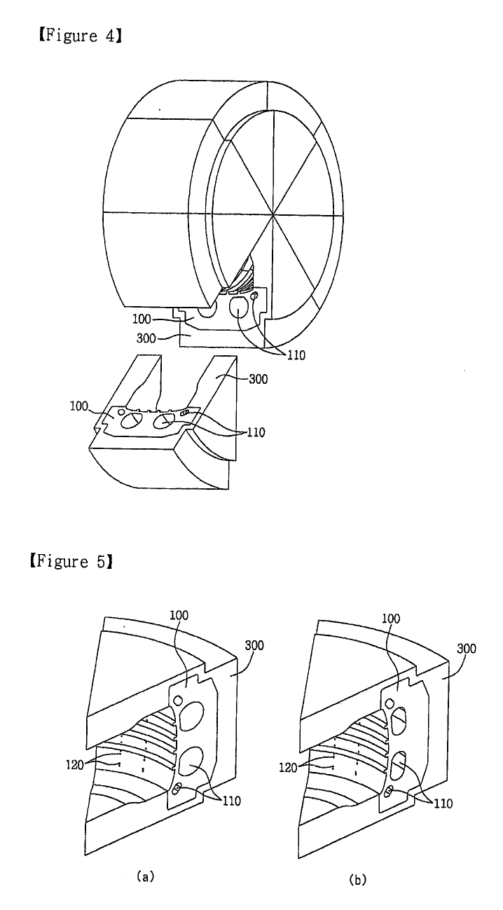

FIG. 4 illustrates an assembled structure of the tire curing mould and a container 300 in accordance with an exemplary embodiment of the present invention. As shown in FIG. 4, the container 300 supports the curing mould and functions as a mould for forming sidewalls of the green tire. The container 300 also has vent holes (not shown) formed through the container 300 in a radial direction of the tire.

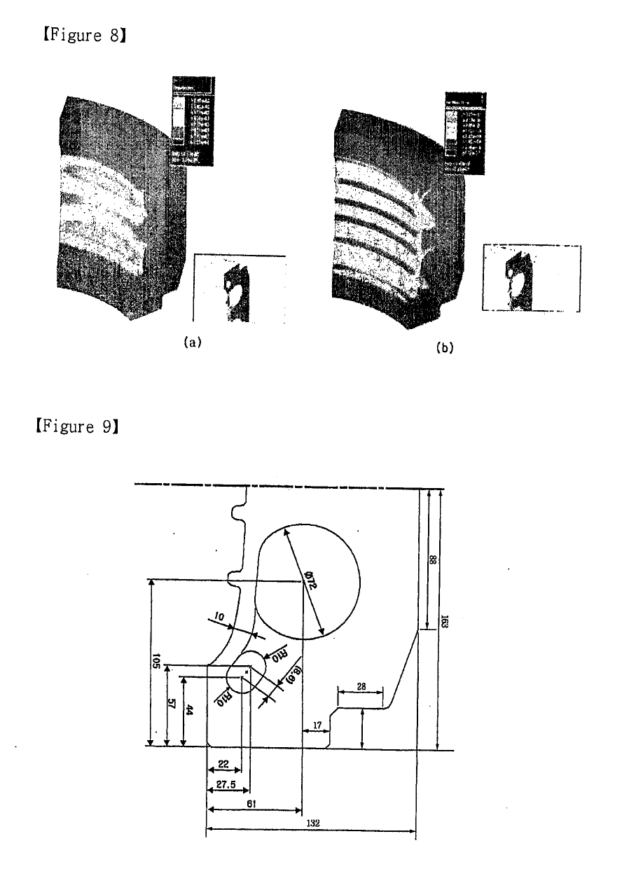

FIGS. 7 and 8 illustrate displacement and stress distributions of the tire, when the tire is cured in the tire curing mould with internal holes in accordance with the present invention. In addition, FIG. 9 illustrates dimensions of the tire curing mould used in a structure analysis, its profile dimension being equal to the dimension of the conventional tire curing mould.

Since the tire curing mould should be operated while engaged with the container 300, a mathematical model of the container 300 is constructed and analyzed with the boundary condition that a profile of the container 300 has perfect confinement (fixed linear and rotational displacement).

In addition, an actually designed curing load, i.e., a pressure of 24 kgf/cm² is applied to the inner surface of the segment mould 100 in contact with the tread.

As a result of the structure analysis, in the case of the structure of FIG. 6A, a maximum displacement of 0.0207 mm is generated between two center through-holes as shown in FIG. 7A, and the stress is relatively uniformly distributed as shown in FIG. 7B to obtain a maximum stress of 17.5 MPa at opposite inner sides of the through-holes. Since the maximum stress is smaller than a tensile strength 115 MPa of a material JIS AC7A, the mould and the container have no problem in terms of strength. In addition, the maximum displacement is small enough not to affect the determination of circularity.

In addition, in the case of the structure of FIG. 6B, a maximum displacement of 0.0163 mm is generated between two center through-holes as shown in FIG. 8A, and the stress is relatively uniformly distributed as shown in FIG. 8B to obtain a maximum stress of 14.0 MPa at opposite inner sides of the through-holes. Since the maximum stress is smaller than a tensile strength 115 MPa of the material JIS AC7A, the mould and the container have no problem in terms of strength. In addition, the maximum displacement is small enough not to affect the determination of circularity.

### INDUSTRIAL APPLICABILITY

As can be seen from the foregoing, a tire curing mould in accordance with the present invention includes a plurality of segment moulds having through-holes disposed in a circumferential direction, whereby it is possible to improve durability and quality of a tire since the stress concentration can be prevented.

In addition, when several vent holes are in fluid communication with the through-holes, inner air can be readily discharged from the mould to prevent the tire from being badly cured and rubber from being stuck in the mould so that its maintenance cost and time can be remarkably reduced.

Further, since separate heat sources can be installed in the through-holes of the segment moulds, and a green tire and the heat source are disposed adjacent to each other, it is possible to increase heat transfer efficiency and minimize curing time. That is, rapid heating and cooling are possible.

Furthermore, the lightweight curing mould is easy to handle and costs associated with manufacturing it from an expensive material (aluminum) can be reduced.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A tire curing mould with internal holes including a plurality of segment moulds disposed in a circumferential direction of a tire and assembled to each other, and a plurality of holes formed through the segment moulds, wherein each of the segment moulds 100 has a through hole 110 formed in a circumferential direction of the segment mould 100.

2. The tire curing mould with internal holes according to claim 1, wherein at least two through-holes 110 are formed in the segment mould 100 symmetrically about a centerline of a cross-section of the segment mould 100.

3. The tire curing mould with internal holes according to claim 2, wherein the through-hole 110 disposed far from the centerline has a size smaller than that of the through-hole disposed adjacent to the centerline.

4. The tire curing mould with internal holes according to claim 3, wherein the through-hole 110 has an oval shape having a long axis in a lateral direction of the tire, or a circular shape.

5. The tire curing mould with internal holes according to claim 4, wherein the through-hole 110 has a flat bottom surface.

6. The tire curing mould with internal holes according to claim 1, wherein at least one vent hole 120 is formed from the inner surface of the segment mould 100 to the through-hole 110.
